(19) United States
(12) Patent Application Publication
(10) Pub. No.: US 2025/0181568 A1
(43) Pub. Date: Jun. 5, 2025

(54) FRAMEWORK FOR THE GENERATION OF SEMANTIC CODES

(71) Applicant: ADP, Inc., Roseland, NJ (US)

(72) Inventors: Steffen Fohn, Lexington, NC (US); Boris Vernoff, Livingston, NJ (US)

(73) Assignee: ADP, Inc., Roseland, NJ (US)

(21) Appl. No.: 18/962,670

(22) Filed: Nov. 27, 2024

Related U.S. Application Data
(60) Provisional application No. 63/604,754, filed on Nov. 30, 2023.

(51) Int. Cl. G06F 16/22; G06F 16/215

(52) U.S. Cl. CPC G06F 16/2291; G06F 16/215

(57) ABSTRACT

Aspects of the technical solution can provide a framework to generate a token data structure to reduce the amount of storage within a database, managing applications associated with at least one remote server. The framework can allow for the token data structure to include a plurality of individual tokens to represent aspects of the application associated with the at least one remote server. When a data processing system receives a request to generate the token data structure for an application, the data processing system can generate the token data structure according to mappings within a token library to define a framework for each token within the token data structure. Once generated, a validation function can traverse the database to verify uniqueness of the generated token data structure. The token data structure is unique when the database does not include a token data structure.

### CROSS-REFERENCES TO RELATED APPLICATIONS

This application claims the benefit of priority under 35 U.S.C. § 119 to U.S. Provisional Patent Application No. 63/604,754, filed Nov. 30, 2023, which is hereby incorporated by reference herein in its entirety.

### TECHNICAL FIELD

The present application is generally related to computing technology, and particularly to a computing framework that is designed, constructed and operational to generate semantic codes for execution.

### BACKGROUND

Enterprises, such as corporations or organizations, can utilize applications to provide a variety of services to clients. These applications can include different functionalities.

### SUMMARY

Aspects of technical solutions described in this application are directed to a computing framework that is designed, constructed, and operational to generate a token data structure to manage databases. For example, due to the growing interconnectivity of remote systems, it can be challenging to implement a standard library or token system to manage databases associated with each remote system or a central server to manage each remote system. Generating codes or tokens for a respective application identifier of each remote system can result in a duplicate tokens when one or more remote systems reference the same application identifier. In time, a database managing the tokens associated with each application identifier of each remote system can grow exponentially resulting in increased utilization, reduced storage, increase computing resource cost, increased latency, and increased delays when accessing the database.

Aspects of the technical solutions described herein provide a framework to generate a token data structure to reduce the amount of storage within a database managing applications associated with at least one remote server. The framework can allow for the token data structure to include a plurality of individual tokens to represent aspects of the application associated with the at least one remote server. When a data processing system receives a request to generate the token data structure for an application, the data processing system can generate the token data structure according to mappings within a token library to define a framework for each token within the token data structure. Once generated, a validation function can traverse the database to verify uniqueness of the generated token data structure. The token data structure is unique when the database does not include a token data structure. By generating the token data structure in this manner, the data processing system can increase available storage, reduce computing resource cost, reduce latency, and reduce the amount of delays within the database. The technical solutions described herein are, thus, rooted in computing technology, and provide improvements to computing technology, particularly, database managing applications. Further, the technical solutions described herein provide practical applications by generating the token data structures, which are used to manage databases

An aspect of the technical solutions described herein can be directed to a system. The system can include one or more processors coupled with memory. The one or more processors can receive, from a computing device, a request indicating an application of a remote server to generate a token data structure including one or more tokens. The one or more processors can determine, responsive to receiving the request. The one or more tokens can map to each element of the application according to a plurality of mappings for each token in the one or more tokens within a library. The one or more processors can generate the token data structure by using the plurality of mappings for each token within the library according to a framework for the one or more tokens within the token data structure. The framework ordering the one or more tokens to identify each element of the application. The one or more processors can identify a flag for the token data structure indicating acceptance or rejection by executing a validation function on a plurality of token data structures. Each token data structure within the plurality of token data structures corresponding to the application of the remote server. The one or more processors can transmit, to the computing device, the token data structure according to the flag indicating acceptance causing the computing device to update the plurality of token data structures to include the token data structure and display the token data structure.

An aspect of the technical solutions described herein can be directed to a method. The method can include receiving, by one or more processors from a computing device, a request indicating an application of a remote server to generate a token data structure including one or more tokens. The method can include determining, by the one or more processors responsive to receiving the request. The one or more tokens can map to each element of the application according to a plurality of mappings for each token in the one or more tokens within a library. The method can include generating, by the one or more processors, the token data structure by using the plurality of mappings for each token within the library according to a framework for the one or more tokens within the token data structure. The framework can order the one or more tokens to identify each element of the application. The method can include identifying, by the one or more processors, a flag for the token data structure indicating acceptance or rejection by executing a validation function on a plurality of token data structures. Each token data structure within the plurality of token data structures corresponding to the application of the remote server. The method can include transmitting, by the one or more processors to the computing device, the token data structure according to the flag indicating acceptance causing the computing device to update the plurality of token data structures to include the token data structure and display the token data structure.

An aspect of the technical solutions described herein can be directed to a non-transitory computer-readable medium that stores processor-executable instructions that, when executed by one or more processors, cause the one or more processors to receive, from a computing device, a request indicating an application of a remote server to generate a token data structure including one or more tokens. The one or more processors can determine, responsive to receiving the request. The one or more tokens can map to each element of the application according to a plurality of mappings for each token in the one or more tokens within a library. The one or more processors can generate the token data structure by using the plurality of mappings for each token within the library according to a framework for the one or more tokens within the token data structure. The framework ordering the one or more tokens to identify each element of the application. The one or more processors can identify a flag for the token data structure indicating acceptance or rejection by executing a validation function on a plurality of token data structures. Each token data structure within the plurality of token data structures corresponding to the application of the remote server. The one or more processors can transmit, to the computing device, the token data structure according to the flag indicating acceptance causing the computing device to update the plurality of token data structures to include the token data structure and display the token data structure.

These and other aspects and implementations are discussed in detail below. The foregoing information and the following detailed description include illustrative examples of various aspects and implementations and provide an overview or framework for understanding the nature and character of the claimed aspects and implementations. The drawings provide illustrations and a further understanding of the various aspects and implementations and are incorporated in and constitute a part of this specification. The foregoing information and the following detailed description and drawings include illustrative examples and should not be considered as limiting.

### BRIEF DESCRIPTION OF THE DRAWINGS

Aspects of the technical solutions described in the present disclosure are described in the detailed description which follows, in reference to the noted plurality of drawings by way of non-limiting examples of exemplary embodiments of the present disclosure.

FIG. 1 is an illustrative example of a system for a framework to generate semantic codes;

FIG. 2 is an illustrative example of a framework used to construct the token data structure;

FIG. 3 is an illustrative example of a components and terms for the token data structure;

FIG. 4 is an illustrative example of framework for the token data structure;

FIG. 5 is an illustrative example of a table with the value domain of Standard Abbreviations for a product solution category;

FIG. 6 is another illustrative example the table of FIG. 5;

FIG. 7 is another illustrative example the table of FIG. 5;

FIG. 8 is another illustrative example the table of FIG. 5;

FIG. 9 is an illustrative example of a table with a value domain of Standard Abbreviations for a role category;

FIG. 10 is an illustrative example of a table with a value domain of the Standard Abbreviations for geographical regions;

FIG. 11 is an illustrative example of a design of the token data structure;

FIG. 12 is an illustrative example of a standard token library within a database;

FIG. 13 is an illustrative example of a web application from a server;

FIG. 14 depicts a table of example token data structures corresponding to example applications; and

FIG. 15 is an illustrative example of a method for the framework to generate semantic codes.

### DETAILED DESCRIPTION

Aspects of the technical solutions described herein provide a framework to generate a token data structure to reduce the amount of storage within a database managing applications associated with at least one remote server. The framework can allow for the token data structure to include a plurality of individual tokens to represent aspects of the application associated with the at least one remote server. When a data processing system receives a request to generate the token data structure for an application, the data processing system can generate the token data structure according to mappings within a token library to define a framework for each token within the token data structure. Once generated, a validation function can traverse the database to verify uniqueness of the generated token data structure. The token data structure is unique when the database does not include a token data structure. By generating the token data structure in this manner, the data processing system can increase available storage, reduce computing resource cost, reduce latency, and reduce the amount of delays within the database.

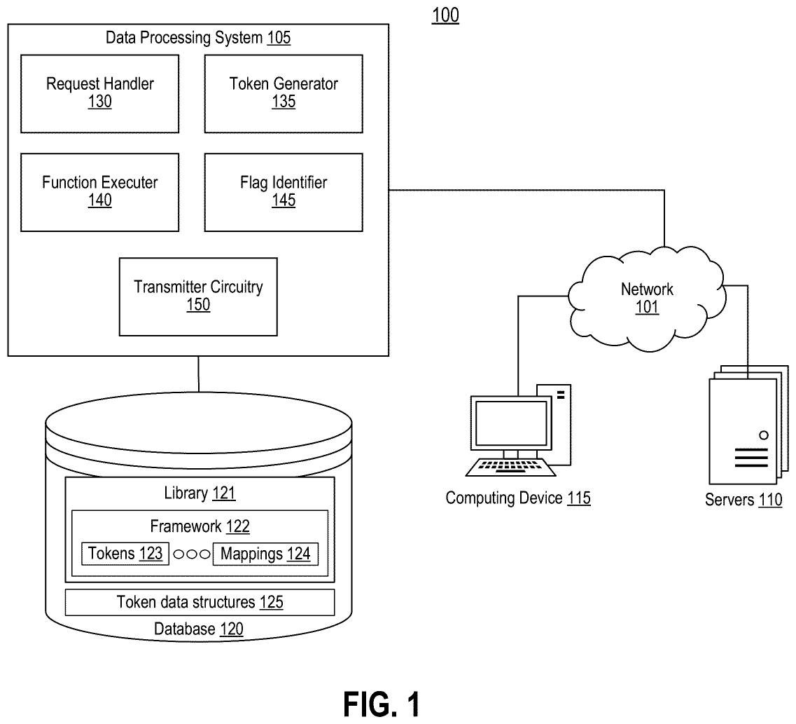

FIG. 1 is an illustrative example system 100 for a framework to generate semantic codes. The system 100 can include at least one data processing system 105, a plurality of servers 110, at least one computing device 115, and at least one database 120. The above-mentioned components may be connected to each other through a network 101. The examples of the network 101 may include, but are not limited to, private or public Local-Area Network (LAN), Wireless Local-Area Network (WLAN), Metropolitan-Area Network (MAN), Wide-Area Network (WAN), and the Internet. The network 101 may include both wired and wireless communications according to one or more standards and/or via one or more transport mediums.

The system 100 is not confined to the components described herein and may include additional or alternate components, not shown for brevity, which are to be considered within the scope of the embodiments described herein.

The data processing system 105 can include at least one processor and a memory, e.g., a processing circuit. The memory can store processor-executable instructions that, when executed by processor, cause the processor to perform one or more of the operations described herein. The processor can include a microprocessor, an application-specific integrated circuit (ASIC), a field-programmable gate array (FPGA), etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions can include code from any suitable computer programming language. The data processing system 105 can include one or more computing devices or servers that can perform various functions as described herein. The data processing system 105 can include any or all of the components and perform any or all of the functions of the server 110. The data processing system 105 can include at least one request handler 130, at least one token generator 135, at least one function executer 140, at least one flag identifier 145, and at least one transmitter circuitry 150.

The request handler 130 can receive requests from the computing device 115 to generate a token data structure. The token generator 135 can determine one or more tokens to map to each element of an application of the server 110. The token generator 135 can generate the token data structure using a plurality of mappings. The function executer 140 can execute a validation function on the plurality of token data structures within the database 120. The flag identifier 145 can identify a flag according to the output of the validation function. The transmitter circuitry 150 can transmit the token data structure to the computing device 115.

The plurality of servers 110 can be a plurality of remote servers 110. The servers 110 can be a specialized computer or software that provides entity information, such as customer data, application data, and financial data, among others forms of data. Servers are generally utilized to store data, facilitate applications corresponding to an application identifier, and offer services to clients. The server 110 may house elements associated with the applications corresponding to the data associated with the server 110. In some instances, the servers 110 can be a data center, a web server, a server room, a plurality of computing devices, among other forms of servers.

The computing devices 115 of the system 100 may hardware and software components configured to perform the various processes and tasks described herein, including one or more processors or software comprising machine-executable instructions executed by the one or more processors. Non-limiting examples of such computing devices 115 of the system 100 include server computers, laptop computers, desktop computers, tablet computers, and smartphone mobile devices, among others. The computing devices 115 may execute webserver software for hosting one or more webpages according to web-related or data-communications protocols and computing languages.

The database 120 can store various types of data related to servers 110, entity data, records, computing device 115 information, among others. The data processing system 105 can access the database 120 when the one or more components of the data processing system 120 requires information (e.g., token data structures 125, library 121) or data to generate the token data structures. The database 107 can include a library 121 and a plurality of token data structures 125 (sometimes referred to as “semantic codes 125” herein). The library 121 can include a plurality of tokens 123 and a plurality of corresponding mappings 124 for elements of an application. The database 120 can include one or more hardware memory devices to store binary data, digital data, or the like. The database 120 can include one or more electrical components, electronic components, programmable electronic components, reprogrammable electronic components, integrated circuits, semiconductor devices, flip flops, arithmetic units, or the like. The database 120 can include at least one of a non-volatile memory device, a solid-state memory device, a flash memory device, and a NAND memory device. The database 120 can include one or more addressable memory regions disposed on one or more physical memory arrays. A physical memory array can include a NAND gate array disposed on, for example, at least one of a particular semiconductor device, integrated circuit device, or printed circuit board device.

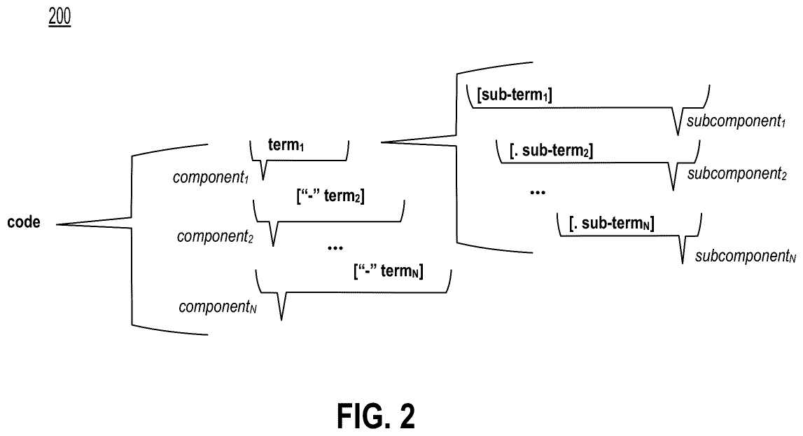

The library 121 may include a framework 122 for design patterns to develop specific naming architectures for specific token data structures 125. The framework 122 can provide the naming and design principles and rules of semantic codes 124 for application, products, business units, and division entities. The framework 122 forms the basis for producing and maintaining semantic codes. FIG. 2 is an illustrative example of the framework 122 used to form the token data structure 125. The framework 122 may include the token data structure 125 (e.g., semantic code) and principles for the token data structure 125. The token data structure 125 may be broken into one or more terms and each term may be broken into two or more sub-terms. Each sub-term can be broken into at least two tokens 123. A first principle may be that a token data structure 125 length can be kept to a minimum (e.g., using abbreviations) as the token data structure 125 may be used in HTTP headers or logs. A second principle may be that token data structure 125 can be self-describing (e.g., discerning) and describing the entity or server 110 the token data structure 125 represents. The token data structure 125 may be used in messages, logs, and annotations, among others.

A third principle may be that the token data structure 125s can adhere a defined “naming architecture” or “naming design.” A fourth principle may be that the token data structure 125 constituent “components” should be consistently named (e.g., avoid synonyms, avoid homonyms). A fifth principle may be that the token data structure 125 “naming architecture” can represent the “design points” (e.g., a product token data structure 125 may include a product name, product data, a product solution, a product from, and a product role). A sixth principle may be that the token data structure 125 should have longevity (e.g., avoid token data structures 125 that may be subject to change). A seventh principle may be that the token data structure 125 should avoid the introduction of tokens that do not help in differentiating one abbreviation from another.

The framework 122 may include naming and design rules for the token data structure 125s. A first rule may be that the token data structure 125 can contain lowercase alphanumeric characters, the dash “-”, the period “.” and the underscore “_.” A second rule may be that the token data structure 125 can start with an alphanumeric character. A third rule may be that the token data structure 125 can end with an alphanumeric character. A fourth rule can be that the token data structure 125 length can be less than or equal to 50 characters. A fifth rule can be that the token data structure 125 can be broken into a set of terms.

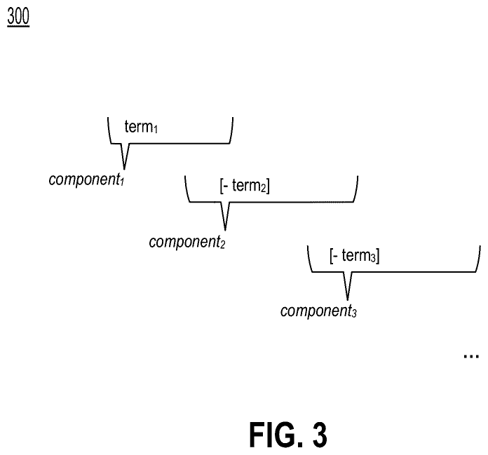

FIG. 3 is an illustrative example of a structure 300 for the token data structure 125. Each term in the set of terms can be separated from any preceding term by the dash “-,” spaces cannot be used, and each term may represent a word or phrase. The term can be broken into a set of sub-terms, where each sub-term represents a concept of the term. For a sub-term, an abbreviation of a word (phrase), representing a single concept, can be delimited from other sub terms by the period “.” (e.g., the term “hr.net” has two sub-terms “hr” and “net” that are delimited by the “.”; the term “abc.def” has two sub-terms “abc” and “def” that are delimited by the “.”; the term “fedrtd.sso” has two sub-terms “fedrtd” and “sso” that are separated by the “.”). Sub-terms in a term may represent multiple constituent concepts explicitly “and'd” together, for example, with the word “and”, or the symbol “&”. It is helpful to both separate and “and” these concepts within the term in order indicate their distinctiveness, when appearing in a single term. In such cases, the abbreviation “et” can be used to delimit/separate and “and” these sub-terms (e.g. the division “Talent &Perf Acceleration” uses the “&” symbol to “and” two concepts, the related token data structure 125 is “ghr-tal.et.perf.accel”; the product “billing and invoice management” uses the “and” word to “and two concepts, the related token data structure 125 is “invcg-int-bill.et.invc.mgt”).

Sub-terms may represent multiple constituent concepts that are not explicitly “and'd” together, but appear adjacent to each other, using the symbols: “-” or “_”. It is helpful to separate these concepts within the term in order indicate their distinctiveness, when appearing in a single term. In such cases, the underscore “_” can be used to delimit these sub terms. (e.g., the division name “Health-Wealth-Tx & Comp” uses the “-” symbol to separate three distinct concepts; the related token data structure 125 can be “hrohlth_with_tax.et.cp”; the division name “HRBP-GPT” uses the “-” symbol to separate two distinct concepts; the related token data structure 125 can be “ghr-hrbp_gpt”; the business unit name “MAS-CAN” uses the. “-” symbol to separate two concepts, the related token data structure 125 can be “mas_ca”).

Sub-terms may represent multiple concepts that are not explicitly “and'd” together, but appear adjacent to each other, using the “/” symbol, that together serve as a qualifier. In such cases, the list of concepts serving as a qualifier can be represented as a conjunction; the conjunction then qualifies the following word (or phrase) (e.g., the division name A/BS/CS Strategy uses the “/” symbol to separate three concepts that together qualify “Strategy”, the related token data structure 125 can be “a.et.bas.srvcs.et.cap.svcs.strtg”; the division name CFO-ESI uses the “-” symbol to separate “ESI” that qualifies “CFO”, the related token data structure 125 can be “gf-esi.cfo”).

In some instances, if the abbreviation of a phrase, representing a single concept, form an acronym, then the period “.” delimiter cannot be used within the acronym (e.g., mas abbreviates major account services, bpm abbreviates business process management). In some arrangements, if an abbreviation is a well-known abbreviation in the enterprise, and it complies with the abbreviation norms, then that abbreviation can be used (e.g., the acronym, mas-major account services). In some arrangements, the same word or phrase may leverage different abbreviations. (e.g., the word, “tax” in the product name, “tax credit services” can be abbreviated to “t” in the token data structure 125 “tcs” while the word “tax” in the product name, “taxware” can be abbreviated to “tax” in the token data structure 125 “taxwr”. This approach can be taken when common abbreviations, such as acronyms, are already in existence and are reused.

Relating again to the token data structure 125, a sixth rule can be that the token data structure 125 may have an optional abbreviation (e.g., core) if the word has six or less characters. A seventh rule can be that the token data structure 125 can avoid the use of “x,” but included when part of the product name (e.g., x reporting).

The framework 122 may have a set of rules for entity-type independent full name naming and design. A first rule in the set of rules can be that the full name accompanying and describing the token data structure 125 can not include any abbreviations. In some arrangements, an exception may occur. The exception can be that an organization's well-known, publicly recognized, abbreviation can be used in the name (e.g., XYZ, ABC). A second in the set of rules can be that the original entity (e.g., server 110) may represent multiple constituent concepts that are explicitly “and'd” together, for example, with the word “and”, or the symbol “&”. In this case, the word “and” can be used to separate those concepts in the full name (e.g., for the original division name, “BC Sls & Mkt Div”, the division token data structure 125 can be “sales-bot.cup.sales.et.mktg.div” and the corresponding division full name can be written as “bottle cup sales and marketing division”).

Continuing on, a third rule in the set of rules can be that the original server 110 may represent multiple constituent concepts that are not explicitly “and'd” together, but appear adjacent to each other, for example an original (source) server 110 may contain a list of concepts using the symbol “/” or “-”. In this case, the dash, “'-” can be used to separate those concepts in the full name (e.g., for the original division name, “SBS/HRO/HRBPO”, the division token data structure 125 can be “gl-sbs_hro_hrbpo” and the corresponding division full name can be written as “small business services-human resource outsourcing-human resource business process outsourcing”). A fourth rule in the set of rules can be that words (or sub-phrases) in a phrase, comprising a single term, may represent multiple concepts that are not explicitly “and'd” together, but appear adjacent to each other, for example an original (source) server 110 may contain a list of concepts using the symbol “/” or “-” that together serve as a qualifier. Further, the list of concepts serving as a qualifier can be represented as a conjunction; the conjunction then qualifies the following word (or phrase) (e.g., the original division name SBS/IS/RS Strategy uses the “/” symbol to separate three concepts that together qualify “Strategy”, the related name can be “small business services and insurance services and retirement services strategy”; the original division name CFO-ESI uses the “-” symbol to separate “ESI” that qualifies “CFO”, the related name can be “employer services international chief financial officer”).

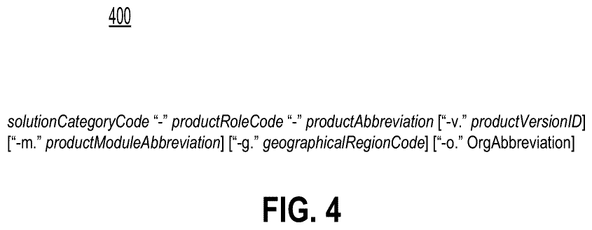

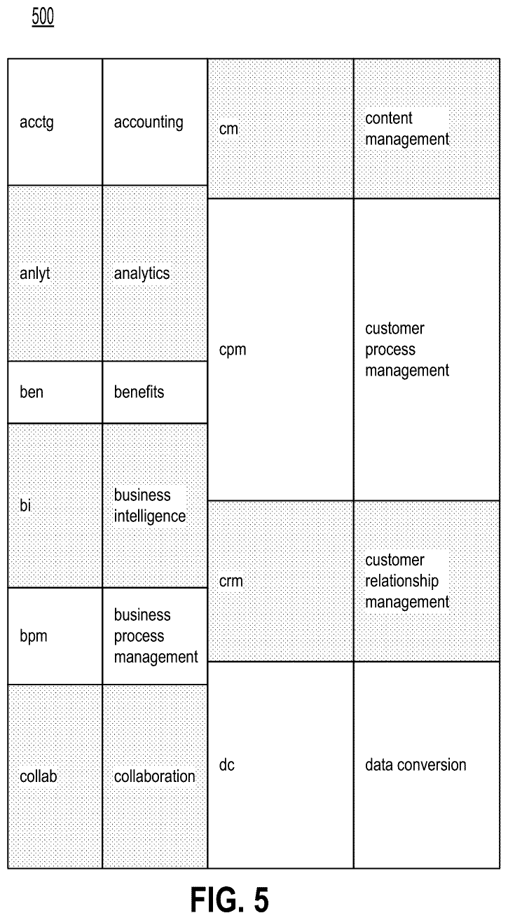

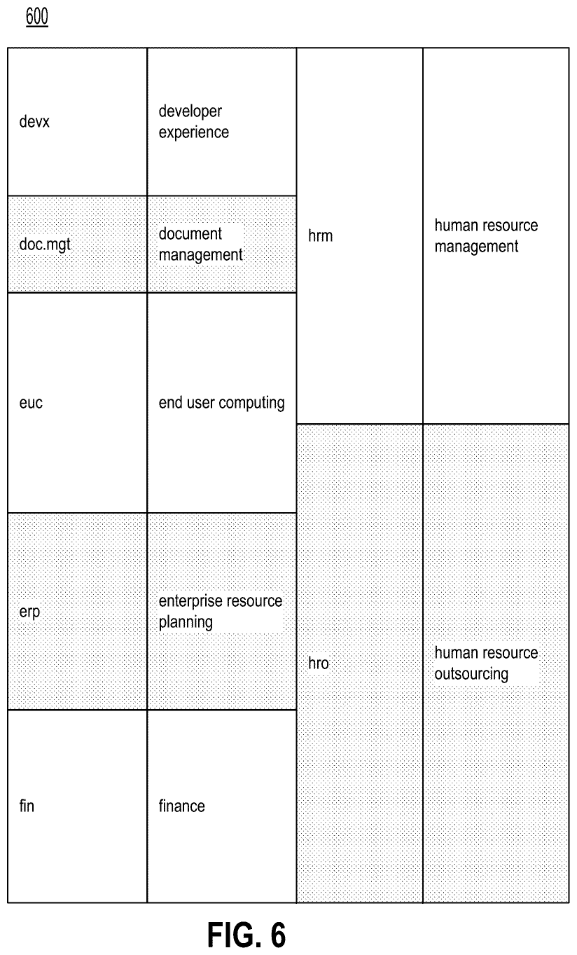

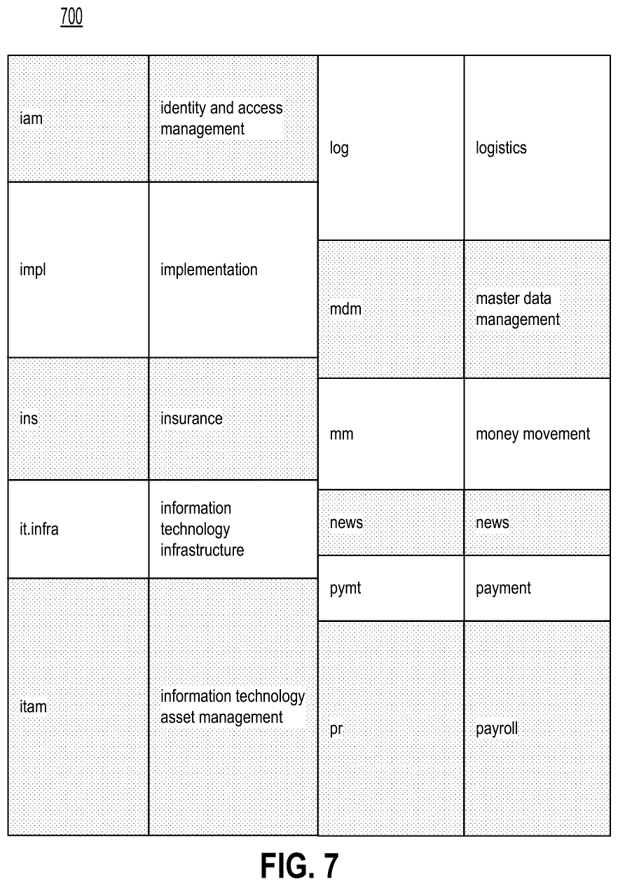

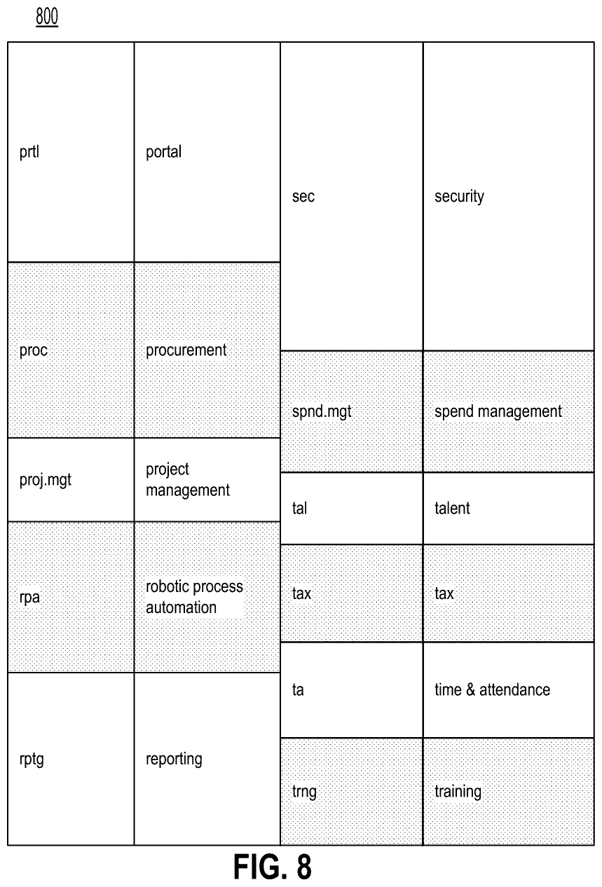

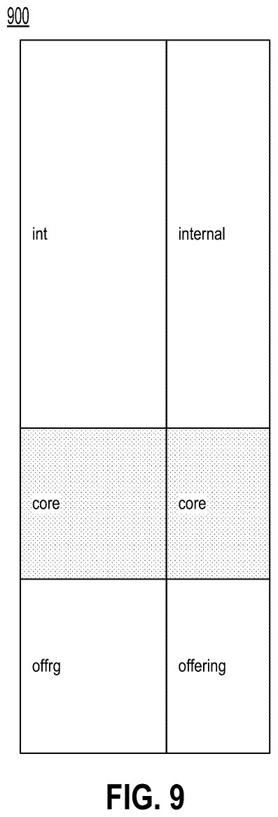

The framework 122 may include a naming design for the token data structure 125. FIG. 4 is an illustrative example of the naming design 400 for the token data structure 125. The naming design 400 may include three or more terms. A first term of the naming design 400 can identify the application's solution category. The solution category categorizes the application according to the solution it provides. The categorization indicates the business or IT function that the application enables. In some arrangements, the solution category can be represented by an abbreviation of the name, limited to the value domain of Standard Abbreviations. A second term of the naming design 400 can include a term identifying the application role. he application role indicates how an application “fits” (e.g., what role it “plays”) in the enterprise; it can be closely related to the type of business process that the application supports or enables. The application role is an orthogonal to the application solution category. A third term of the naming design 400 can include a term representing the application. The application can be represented by an abbreviation of the name, limited to the value domain of Standard Abbreviations. FIGS. 5-8 are illustrative examples of a table 500, 600, 700, and 800 respectively, with the value domain of Standard Abbreviations for an application solution category. Furthermore, FIG. 9 is an illustrative example of a table 900 with the value domain of the Standard Abbreviations for an application role.

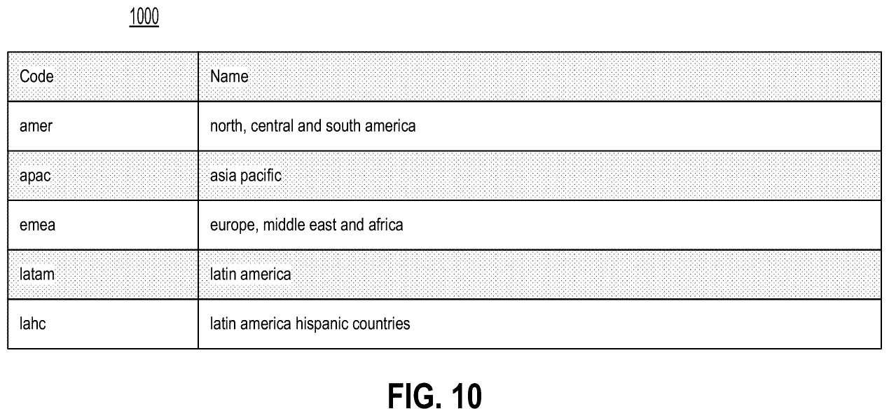

Continuing on, a fourth term can be that if an application's version is required to distinguished it from another application and/or product version, then the naming design 400 can include a term representing the version. The term representing a version can be prefixed by the “v” meta character. Furthermore, the version can be represented by numeric values. A fifth term if the application is a module (e.g., is part of another application), then the Naming design 400 can include both a term representing the base application and another term representing the module. The term representing module can be prefixed by the “m” meta character. The module can be represented by an abbreviation of the name, limited to the value domain of Standard Abbreviations. A sixth term can be that if an application's service geographical region is required to distinguished it from another application, then the naming design 400 can include a term representing the service geographical region. The term representing a service geographical region can be prefixed by the “g” meta character. The service geographical region can be represented by an element of value domain of ISO 3166-1:2002 (two character letter token data structure 125 for countries), the UN M.49 (three character numeric for macro geographical regions), entity-defined world sub-regions, or ISO 3166-2 (up to three character letter token data structure 125 for country subdivisions, following the two character letter country token data structure 125 and a hyphen “-”); the entity-defined world subregions can be used when a geographical region is not already represented in the ISO 3166-1:2002 and the UN M.49 token data structure 125 lists. FIG. 10 is an illustrative example of a table 1000 with the value domain of the Standard Abbreviations for geographical regions.

The framework 122 may include a set of rules for an external entity (e.g., server 120) to ADP. A first rule in the set of rules can be that if the application's provider organization is external to ADP, then the application's full name can include the organization's name, where the organization's name can precede (and qualify) the actual application name (e.g., the full name “answer system” includes the name of the organization, “answer” which precedes the name of the base application, “system”). A second rule in the set of rules can be that if the application entity is an application item (i.e., a version of an application), then the full name can include the version identification in addition to the full name of the parent base application. The “version” keyword can precede the version identification. (e.g., the full name “enterprise electronic time version 7.0” includes the name of the base application, “enterprise electronic time” followed by the version identification, “7.0”). A third rule in the set of rules can be that if the application entity is an application instance (i.e., an instance of a base application or an application item), then the full name can include the instance identification in addition to the full name of the parent base application or application item. The “instance” keyword can precede the instance identification (e.g., the full name “micro instance xx” includes the name of the base application, “micro” followed by the instance identification, “xx”).

The framework 122 may include a naming design for a business unit token data structure 125. The business unit can be named by a phrase or a single word and may include a single term. The term can be represented by an abbreviation of the name, limited to the value domain of Standard Abbreviations. The framework 122 may include a naming design for a business unit division. The business unit division may include two terms. A first term representing a business unit can correspond to the business unit token data structure 125. A second term representing a business unit division can be represented by an abbreviation of the name, limited to the value domain of Standard Abbreviations.

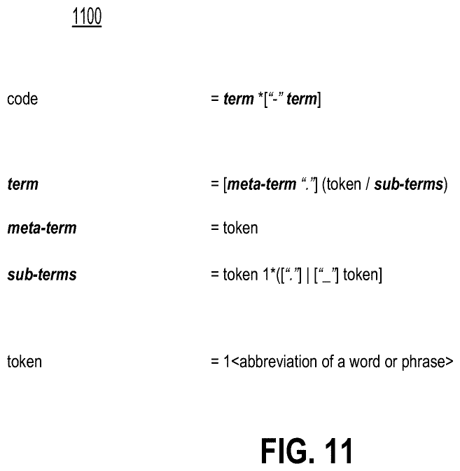

The framework 122 may include software and hardware components to generate the semantic token data structure 125, using the general naming architecture. FIG. 11 is an illustrative example of a design 1100 of the token data structure 125. In some arrangements, the term represents a component of the token data structure 125 and can be qualified by a meta-term. In some arrangements, the term can be a token 123 representing a word, phrase, or an abbreviation from the server 110 and may comprises sub-terms. The meta-term can be a token 123 representing a word or phrase corresponding to metadata. The sub-term represents a subcomponent of the token data structure 125 and may include two or more tokens 123.

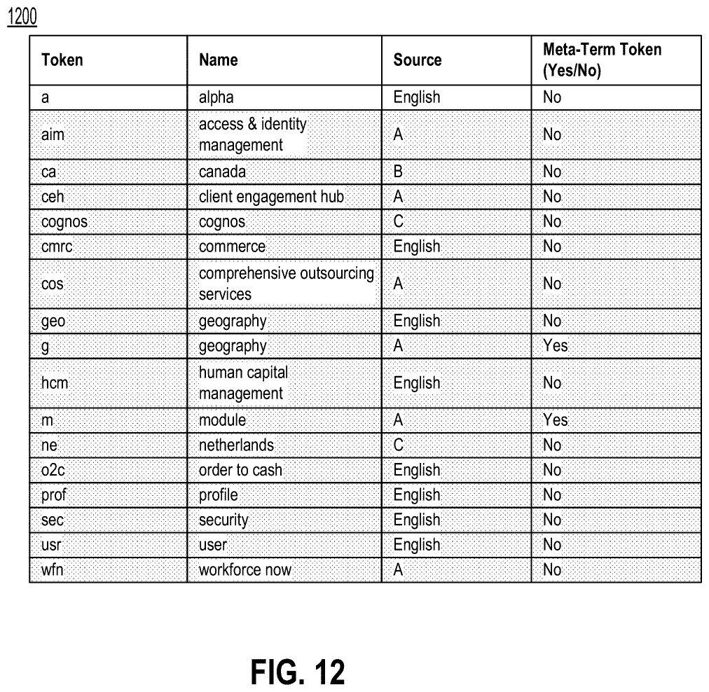

The database 120 may include a standard, reusable, and extensible library of tokens defined by a standard token library. FIG. 12 is an illustrative example of a standard token library 1200 within a database 120. In some arrangements, the standard token library may serve as the value domain for the meta-term tokens 123, the term tokens 123, and the sub-term tokens 123. The tokens 123 correspond to a name and source based on the rules and terms defined by the framework 122. In some arrangements, the tokens 123 are abbreviations of words and phrases.

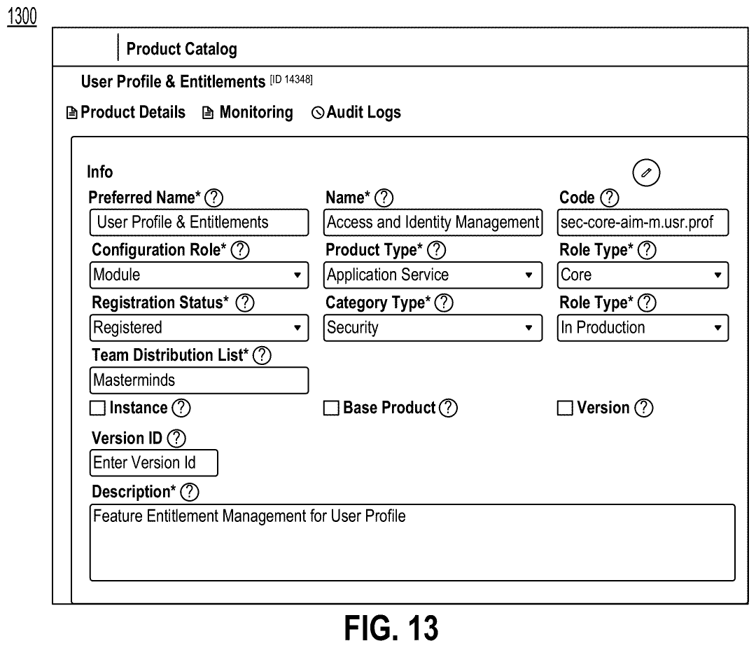

The request handler 130 can monitor, detect, or otherwise receive interactions with the computing device 115. The computing device 115 can display a web application using one or more graphical elements. FIG. 13 is an illustrative example of the web application 1350 displayed on the computing device 115. The web application 1350 can include a plurality of graphical user interface elements to receive process one or more input methods. The one or more input methods can include at least one of a mouse, a keyboard, a stylus, a controller, a sensor, among other input methods. For example, a user can use the keyboard of the computing device 115 to input information into the web application 1350. The request handler 130 can detect each interaction with the computing device 115 and generate metadata associated with the interactions. For example, some metadata can indicate the web address of the server 120. In another example, some metadata can indicate the entity associated with the server 120.

The request handler 130 can receive, obtain, or otherwise retrieve a request from the computing device 115. The request can include data associated with the interactions with the web application 1350. The request handler 130 can receive, obtain or otherwise retrieve the request from the computing device 115 responsive to detecting an interaction. The data can include the metadata, the interactions, the interaction times, the entity associated with the server 110, among other data. For example, the request can indicate at least one server 110 associated with an entity within the web application 1350. Each server 110 can correspond to an application identifier (referred to as application herein) that can be at least one of a product, business unit, geographical location, among other information regarding the respective server 110. In some instances, the servers 110 can reference the same application. In some instances, each server 110 can represent different applications. The application can correspond to a good or server that supports an external need by the server 110 or an internal need by the computing device 115. Thereby, upon reception of the request, the request handler 130 can receive the applications associated with a respective server 110. For example, the application can correspond to a scheme of the server 110. Based on the applications, the request handler 130 can sort the applications to improve the generation of the token data structures 125. Upon reception of the request, the request handler 130 can cause the data processing system 105 to generate, construct, or otherwise create the token data structure 125 for the application associated with the server 110.

In some instances, the data within the request can associate or correspond to a token data structure 125 within the database 120. For example, the request received from the computing device can include a business unit and geographical location that corresponds to at least one term within the stored token data structure 125. The request handler 130 can trigger the transmitter circuitry 150 to transmit a message to the computing device 115 indicating that the token data structure 125 for the application is located within the database 120. In this manner, the systems and methods described herein can efficiently save computing resources by re-using token data structures 125 within the database 120 upon the data processing system 105 detecting at least one similarity between the data within the request and the token data structures. To further save on utilization, the request handler 130 can temporality store similarities within cache memory to prevent queries of the database 120 upon reception of every request from then computing device 115.

The token generator 135 can determine, identify, or otherwise indicate the one or more tokens 123 to map to each element of the application according to a plurality of mappings 124 for each token 123 within the library 121. The token generator 135 can determine the one or more tokens 123 in response to the request handler 130 receiving the request. Each token 123 can map to at least one mapping 124 within the plurality of mappings 124. Each mapping 124 can correspond to an element of the application. The elements of the application can correspond to a name, a role, a product type, a role type, a registration status, a category type, among other aspects of an application associated with the respective server 108 as shown in FIG. 13. For example, a token 123 (e.g., “a”) can map to a name (e.g., “alpha”) as shown in the table 1200 of FIG. 12. The token generator 135 can iteratively determine each token 123 for the token data structure 125 based on the mapping 124 for each token 123.

Once each token 123 is determined, the token generator 135 can generate, create, or otherwise construct the token data structure 125 using the plurality of mappings 124 according to the framework 122 as shown in FIG. 4. The framework 122 can provide an order for each determined token 123 to construct the token data structure 125. Based on the framework 122, the computing device 115 can identify each element of the application associated with the server 110. For example, the framework 122 can indicate that the order of the tokens 123 within token data structure 125 can be “solutionCategoryCode”-“productRoleCode”-“geographicalRegionCode.” In another example, the framework 122 can indicate that the order of the tokens 123 within token data structure 125 can be “productRoleCode”-“productAbbreviation”-“orgAbbreviation.” In this manner, the computing device 110 and the data processing system 105 can quickly generate a token data structure 125 according to the framework 122 for each token 123.

As shown in FIG. 11, the token data structure 125 can include a plurality of terms. Each term in the plurality of terms can include a plurality of meta-terms, a plurality of sub-terms, and the one or more tokens 123. Each meta-term can include at least one token 123 and each sub-term can include at least two tokens 123. Using the meta-terms, sub-terms, and the tokens 123, the token generator 135 can generate, determine, or otherwise identify the plurality of terms by constructing the one or more tokens 123 into the one or more meta-terms and the one or more sub- terms according to the framework 122. The framework 122 can indicate each term in the plurality of terms to generate the token data structure 125. By generating the token data structures 125 in this manner, the systems and methods described herein can generate unique token data structures 125 to reduce the number of duplicate token data structures 125 within the database 120. The token data structure 125 can be represented as a set to enable the data processing system to achieve a search of O (1) when executing a validation function on the database 120.

To ensure uniqueness of the generated token data structure 125, the function executer 140 can implement, execute, or otherwise perform the validation function on the plurality of token data structures 125. The validation function can be computer readable instructions implemented in Java, Ruby, Python, Rust, C#, SQL, Swift, Bash, Kotlin, Go, among other programming languages. The validation function can identify, verify, or otherwise determine that the order of the tokens 123 within the generated token data structure 125 do not exist within at least one token data structure 125 within the plurality of data structures 125 stored within the database 120. For example, the validation function can indicate that the generated token data structure 125 corresponds to at least one token data structure 125 within the database 120. In another example, the validation function can indicate that the generated token data structure 125 corresponds to at least two token data structures 125 within the database 120. In yet another example, the validation function can indicate that the generated token data structure 125 does not correspond to any token data structures 125 within the database 120.

During execution of the validation function on each token data structure 125 within the database 120, the function executer 140 can parse, access, or otherwise analyze a respective token data structure 125 to extract each token 123 corresponding to the elements of the application associated with the respective token data structure 125. The function executer 140 can iteratively extract each token 123 within the respective token data structure 125 and extract each token 123 within the generated token data structure 125. For example, upon execution of the validation function, the function executer 140 can parse a first token data structure 125 and extract the one or more tokens 123 that form the first token data structure 125. Concurrently, the function executer 140 can parse the generated token data structure 125 and extract the one or more tokens 123 that form the generated token data structure 125.

Upon the extraction of each token 123, the function executer 140 can compare each token 123 of the respective token data structure 125 with each token 123 of the generated token data structure 125 to identify a match between the respective token data structure 125 and the token data structure 125. For example, tokens 123 of the respective data structure 125 can include “a” and “ca,” whereas tokens 123 of the generated data structure 125 can include “a” and “ca.” From here, the validation function can cause the function executer 140 can first compare “a” on each token data structure 125 then compare “ca” on each token data structure 125. In another example, tokens 123 of the respective data structure 125 can include “a” and “ca,” whereas tokens 123 of the generated data structure 125 can include “a”, “ca”, and “hcm” From here, the validation function can cause the function executer 140 can first compare “a” on each token data structure 125 then compare “ca” on each token data structure 125, however, the function executer 140 cannot compare “hcm” since there is no corresponding token in at least one token data structure 125. In some instances, the function executer 140 can filter the token data structures 125 within the database 120 according to at least one of the tokens 123 within the generated token data structure 125. For example, a first token 123 of the generated token data structure 125 can be “ne.” Using the first token 123, the function executer 140 can filter the plurality of token data structures 125 to use respective token data structures 125 that include the first token 123.

Once compared, the function executer 140 can identify that the generated token data structure 125 does not match the respective token data structure 125 based on the comparison of each token 123 of the respective token data structure 125 and each token 123 of the token data structure. To identify that the token data structures 125 do not match, at least one token 123 in the respective token data structure 125 can be different from the tokens 123 within the generated data structure 125. For example, tokens 123 of the respective data structure 125 can include “a” and “ca,” whereas tokens 123 of the generated data structure 125 can include “a” and “cos.” From here the function executer 140 can determine that the respective token data structure 125 is different from the generated token data structure 125 from the difference between token “ca” and token “cos.”

The function executer 140 can identify that the token data structure 125 matches the respective token data structure based on the comparison of each token 123 of the respective token data structure 125 and each token 123 of the token data structure 125. To identify that the token data structures 125 match, each token 123 in the respective token data structure 125 can be the same as each token 123 within the generated data structure 125. For example, tokens 123 of the respective data structure 125 can include “a” and “ca,” whereas tokens 123 of the generated data structure 125 can include “a” and “ca.” From here, the function executer 140 can determine that the respective token data structure 125 is a match with the generated token data structure 125 from the similarity between each token 123. Once determined, the function executer 140 can reuse the respective token data structure 125 and discard the generated token data structure 125 prior to storage to save computing resources and reduce maintain the size of the database 120.

By executing the validation function and using the token data structure as described, the systems and methods described herein can prevent the continuous growth of the database 120 by verifying the token data structures 125 and re-using the matched token data structures 125. By preventing the continuous growth, the systems and methods described herein can reduce query and search times for the database 120 by generating the unique tokens for the respective application associated with the server 110. Therefore, the systems and methods described herein can improve the quality of the stored data by forming new tokens upon requests if the tokens are not already stored within the data base 120.

Upon completion of the validation function, the flag identifier 145 can identify, assign, or otherwise generate a flag for the token data structure 125. The flag can be a value, a bit, an indicator, a status, a notification, a marker, among other representations, to indicate a condition or a state for the generated token data structure 125. The condition can be at least one of an acceptance of the token data structure 125 or a rejection of the token data structure 125. The flag identifier 145 can identify the flag based on the execution of the validation function on the plurality of token data structures 125 within the database 120. In some instances, the flag identifier 145 can generate a message corresponding to the flag. For example, the flag identifier 145 can generate a message according to an acceptance of generated token data structure 125 indicting that the token data structure 125 is unique. In this manner, using the flag based on the output of the validation function, the systems and methods described herein can quickly compare the token data structures 125 to generate the message to indicate the condition of the token data structure 125.

The flag identifier 145 can update, adjust, or otherwise modify the flag to indicate acceptance, in response to the token data structure 125 not matching the at least one token data structure 125 within the database 120. To update the flag, the flag identifier 145 can modify the value of the flag to correspond to acceptance. For example, the flag identifier can change a bit of the flag to 1 to indicate the acceptance of the token data structure 125. By indicating acceptance, the flag identifier 145 can trigger the token generator 135 to store the generated token data structure 125 and generate the message for transmission to the computing device 115. When the flag indicates acceptance, the generated token data structure 125 can be unique in amongst the token data structures 125 within the plurality of data structures 125 within the database 120.

The flag identifier 145 can update, adjust, or otherwise modify the flag to indicate rejection, in response to the token data structure 125 matching the at least one token data structure 125 within the database 120. To update the flag, the flag identifier 145 can modify the value of the flag to correspond to a rejection. For example, the flag identifier 145 can change a bit of the flag to 0 to indicate the rejection of the token data structure 125. By indicating a rejection, the flag identifier 145 can trigger the token generator 135 to disregard the generated token data structure 125 and generate the message for transmission to the computing device 115. When the flag indicates rejection, the generated token data structure 125 is not unique in amongst the token data structures 125 within the plurality of token data structures 125 within the database 120.

Upon the rejection of the flag, the token generator 135 can determine, generate, or otherwise identify second tokens 123 to update the flag. To identify the second tokens 123, the token generator 135 can use the plurality of mappings 124 within the library. The plurality of mappings 124 can indicate alternatives to each token 123 when the flag indicates a rejection. Using the alternatives, the token generator 135 can determine second tokens 123. Using the second tokens 123, the token generator 135 can generate, create, or otherwise construct a second token data structure 125 using the plurality of mappings 124 according to the framework 122 as shown in FIG. 4. The framework 122 can provide an order for each alternative token 123 to construct the second token data structure 125. Based on the framework 122, the computing device 115 can identify each element of the application associated with the server 110. For example, the framework 122 can indicate that the order of the alternative tokens 123 within token data structure 125 can be “solutionCategoryCode”-“geographicalRegionCode.” In another example, the framework 122 can indicate that the order of the tokens 123 within token data structure 125 can be “productAbbreviation”-“orgAbbreviation.” In this manner, the computing device 110 and the data processing system 105 can quickly generate a second token data structure 125 according to the framework 122 for each token 123.

Upon generation of the second token data structure 125 and completion of the validation function, the flag identifier 145 can assign, identify, or otherwise generate a subsequent flag for the second data structure 125. The subsequent flag can be a value, a bit, an indicator, a status, among other representations, to indicate a condition or a state for the generated token data structure 125. The condition can be at least one of an acceptance of the second token data structure 125 or a rejection of the second token data structure 125. The flag identifier 145 can identify the subsequent flag based on the execution of the validation function on the plurality of token data structures 125 within the database 120. In some instances, the flag identifier 145 can generate a message corresponding to the subsequent flag. For example, the flag identifier 145 can generate a message according to an acceptance of generated token data structure 125 indicting that the second token data structure 125 is unique. In this manner, using the flag based on the output of the validation function, the systems and methods described herein can quickly compare the token data structures 125 to generate the message to indicate the condition of the second token data structure 125. Despite two token data structures 125 being described within this disclosure, it is appreciated that this can occur for a plurality of generated token data structures 125

The transmitter circuitry 150 can transmit, send, or otherwise provide the token data structure 125 or the second token data structure 125 to the computing device 115. The flag identifier 145 can trigger the transmitter circuity 150 to transmit the token data structure 125 in response to the flag or the subsequent flag indicating acceptance. For example, responsive to the flag indicating acceptance, the transmitter circuitry 150 can transmit the token data structure 125 to the computing device 115. Concurrently, the transmitter circuitry 150 can store the token data structure 125 within the plurality of token data structures 125 within the database 120.

The computing device 115 can utilize the token data structure 125 to extract metadata according to the needs of an entity, a server 110, a business, an employee, among others. For example, the computing device 115 can use the token data structure 125 to identify an entity based on the mapped application. In another example, the computing device 115 can use metadata associated with the token data structure to allow for efficient search and discovery of the application within the database 120. Non-limiting examples of the use of the token data structures 125 can include virtual private cloud users to relate a public cloud to an application, source code management system user to relate a repository to an application, authorization application programming interface message to associate a permission to an application, an HTTP message header to associate a message instance to an application, among other non-limiting examples.

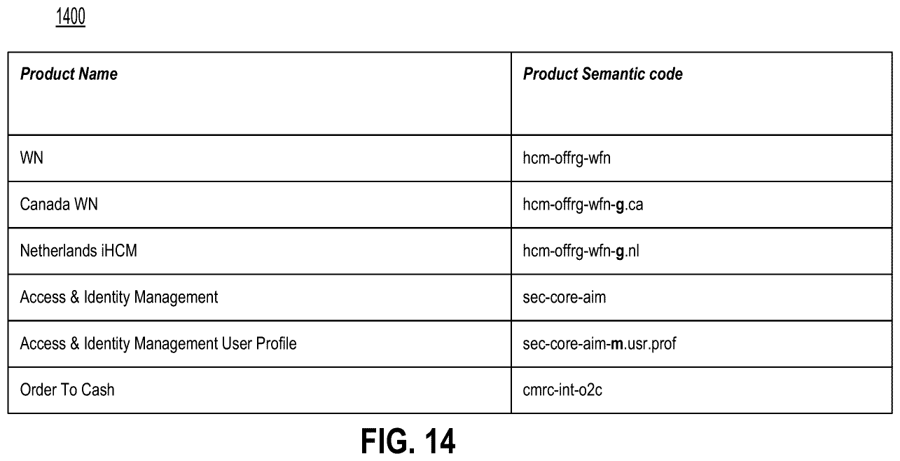

Along with the token data structure 125, the transmitter circuitry 150 can transmit instructions to the computing device 115 to cause the computing device to display the token data structure 125. The instructions can include processing instructions for display of the token data structure 125 based on user interface (UI) elements of the computing device 115. The UI elements can correspond to visual components of the user interface of the computing device 115, such as a command button, a text box, a check box, a radio button, a menu item, and a slider, among others visual components. As shown to FIG. 14. FIG. 14 depicts a table of example token data structures 125 corresponding to example applications associated with a respective server 110.

In this manner, the system and methods described herein can increase available storage, reduce computing resource cost, reduce latency, and reduce the amount of delays within the database 120. For example, using the framework 122 within the library 121, the token generator 135 can ensure uniqueness for each application associated with each server 110 to control the growth of the database 120 by storing the unique token data structures 125 and reusing the non-unique token data structures. In another example, the function executer 140 can match token data structures 125 by filtering according to the application or the tokens 123 to reduce the search time associated with querying the database 120. Furthermore, using the data processing system 105, the computing device 115 can be provided with the result of the request (e.g., generation of token data structure 125 or reuse of the token data structure 125) in real time or near-real time.

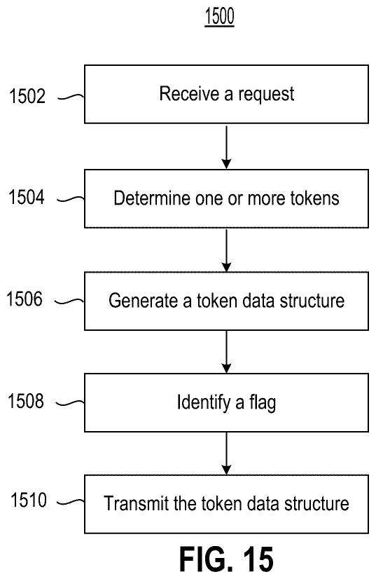

FIG. 15 is an illustrative example of a method 1500 for the framework to generate semantic codes. The method 1500 can be performed by one or more processors (e.g., data processing system 105). The method 1500 can be performed by one or more components depicted in FIG. 1. At step 1502, the one or more processors receive, from a computing device, a request to generate a token data structure including one or more tokens. At step 1504, the one or more processors can determine, responsive to receiving the request, the one or more tokens to map to each element of the application according to a plurality of mappings for each token in the one or more tokens within a library. At step 1506, the one or more processors can generate the token data structure by using the plurality of mappings for each token within the library to define a framework for the one or more tokens within the token data structure. At step 1508, the one or more processors can identify a flag for the token data structure indicating acceptance or rejection by executing a validation function on a plurality of token data structures indicating that the token data structure does not match at least one token data structure within the plurality of token data structures. At step 1510, the one or more processors can transmit, to the computing device, the token data structure according to the flag indicating acceptance causing the computing device to update the plurality of token data structures to include the token data structure and display the token data structure.

By utilizing the token data structures 125, the systems and methods described herein can improve management of the database 120. For instance, prior system often rely on managing existing data within the database, without addressing the underlying causes for exponential growth such as accumulation of obsolete data, data lifecycle management, deduplication, archiving without purging, among other causes. The system and methods described herein addresses each of these causes to improve the overall management of the database by utilizing the token data structures 125. For example, the function executer 140 can use the tokens 123 of a generated token data structure 125 to ensure uniqueness to prevent the addition of duplicate data. To manage archiving, the token data structures 125 are organized according to the framework 122 within the library 121. In this manner, the token data structures 125 are separated according to the mapping to the respective server 110, thereby allowing the database to store the token data structures 125 based on the mapping to the server 110. Since each server 110 indicates specific applications for the token data structure, the systems and methods described herein relive the necessity to archive unused token data structures 125 as the token data structures 125 correspond directly to applications of the server 110.

The use of the token data structures 125 improve query optimization for the database 120 by allowing the database 120 to implement effecting query execution plans, improve index use, optimize joins, utilize query caching, partition tables, optimize sorting. For example, the use of the token data structures 125 support partitioning the tables of the database 120 according to the mapping to the application of the respective server 110. In another example, the framework 122, to organize the tokens 123 within the token data structure 12, can enable query caching for the applications of a respective server 110 by quickly identifying whether the token data structure 125 is unique compared to previously generated token data structure 125. In this manner, the use of the token data structures 125 as developed by the systems and methods described herein, improve the management of databases.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encode in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an

FPGA (field programmable gate array) or an ASIC (application specific integrated circuit). The apparatus can also include, in addition to hardware, token data structure 125 that creates an execution environment for the computer program in question, e.g., token data structure 125 that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or token data structure 125) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of token data structure 125). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and cannot be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B”’ can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors coupled with memory, the one or more processors to:
receive, from a computing device, a request to generate a token data structure comprising one or more tokens, the request indicating an application for which the token data structure is to be generated;
determine, responsive to receiving the request, the one or more tokens to be mapped to each element of the application according to a plurality of mappings for each token within a library;
generate the token data structure by using the plurality of mappings for each token within the library according to a framework for the one or more tokens within the token data structure, the framework setting an order of the one or more tokens to identify each element of the application;
assign a flag to the token data structure, the flag indicative of acceptance or rejection of the token data structure, the flag is generated by executing a validation function on a plurality of token data structures within a database, each token data structure of the plurality of token data structures corresponding to the application; and
transmit, to the computing device, the token data structure responsive to the flag indicating acceptance to cause the computing device to update the plurality of token data structures to include the token data structure and display the token data structure.

2. The system of claim 1, the one or more processors to:
execute the validation function on the plurality of token data structures to identify the flag for the token data structure; and
update the flag to indicate acceptance, responsive to the token data structure not matching at least one token data structure of the plurality of token data structures.

3. The system of claim 1, wherein the one or more processors are further configured to:
execute the validation function on the plurality of token data structures to identify the flag for the token data structure; and
update the flag to indicate rejection, responsive to the token data structure matching at least one token data structure of the plurality of token data structures.

4. The system of claim 3, the one or more processors to:
generate, responsive to the flag indicating rejection, a second data structure by using the plurality of mappings for each token within the library to define the framework for the one or more tokens within the second token data structure;
identify a flag for the second token data structure indicating acceptance or rejection by executing the validation function on the plurality of token data structures; and
transmit, to the computing device, the second token data structure according to the flag indicating acceptance causing the computing device to update the plurality of token data structures to include the second token data structure and display the second token data structure.

5. The system of claim 1, wherein, to execute the validation function, the one or more processors to:
for each token data structure in the one or more token data structures,
parse a respective token data structure to extract each token corresponding to each elements of the application;
compare each token of the respective token data structure with each token of the token data structure to identify a match between the respective token data structure and the token data structure; and
identify that the token data structure does not match the respective token data structure based on the comparison of each token of the respective token data structure and each token of the token data structure.

6. The system of claim 1, wherein, to execute the validation function, the one or more processors to:
for each token data structure in the one or more token data structures,
parse a respective token data structure to extract each token corresponding to each elements of the application;
compare each token of the respective token data structure with each token of the token data structure to identify a match between the respective token data structure and the token data structure; and
identify that the token data structure matches the respective token data structure based on the comparison of each token of the respective token data structure and each token of the token data structure.

7. The system of claim 1, wherein the token data structure comprises a plurality of terms, each term in the plurality of terms comprises a plurality of meta-terms, and a plurality of sub-terms, wherein each sub-term in the plurality of sub-terms comprises two or more tokens.

8. The system of claim 7, wherein, to generate the token data structure, the one or more processors to generate the one or more terms by forming the one or more tokens into the one or more meta-terms and the one or more sub-terms according to the framework.

9. The system of claim 1, wherein the token data structure corresponds to first elements of the application and at least one token data structure within the plurality of data structures corresponds to second elements of the application.

10. The system of claim 1, wherein each token in the one or more tokens corresponds to at least one of a word, a phrase, or an abbreviation within the library.

11. The system of claim 1, wherein the one or more processors to generate the token data structure according to one or more rules for the one or more tokens defining alphanumeric characters for use by the one or more tokens.

12. The system of claim 1, wherein each element of the application include at least one of category, a configuration, and a role.

13. A method for semantic code delivery framework comprising:
receiving, by one or more processors, from a computing device, a request to generate a token data structure including one or more tokens, the request indicating an application for which the token data structure is to be generated;
determining, by the one or more processors responsive to receiving the request, the one or more tokens to be mapped to each element of the application according to a plurality of mappings for each token within a library;
generating, by the one or more processors, the token data structure by using the plurality of mappings for each token within the library according to a framework for the one or more tokens within the token data structure, the framework setting an order the one or more tokens to identify each element of the application;
identifying, by the one or more processors, a flag for the token data structure, the flag indicative of acceptance or rejection of the token data structure, the flag is generated by executing a validation function on a plurality of token data structures, each token data structure of the plurality of token data structures corresponding to the application; and
transmitting, by the one or more processors to the computing device, the token data structure responsive to the flag indicating acceptance causing the computing device to update the plurality of token data structures to include the token data structure and display the token data structure.

14. The method of claim 13, further comprising:
executing, by the one or more processors, the validation function on the plurality of token data structures to identify the flag for the token data structure; and
updating, by the one or more processors, the flag to indicate acceptance, responsive to the token data structure not matching at least one token data structure of the plurality of token data structures.

15. The method of claim 13, wherein executing the validation function further comprises:
for each token data structure in the one or more token data structures,
parsing a respective token data structure to extract each token corresponding to each element of the application;
comparing each token of the respective token data structure with each token of the token data structure to identify a match between the respective token data structure and the token data structure; and
identifying that the token data structure does not match the respective token data structure based on the comparison of each token of the respective token data structure and each token of the token data structure.

16. The method of claim 13, wherein the token data structure comprises a plurality of terms, each term in the plurality of terms comprises a plurality of meta-terms and a plurality of sub-terms, wherein each sub-term in the plurality of sub-terms comprises two or more tokens.

17. The method of claim 16, wherein generating the token data structure further comprises generating the plurality of terms by forming the one or more tokens into the plurality of meta-terms and the plurality of sub-terms according to the framework.

18. The method of claim 13, wherein the token data structure corresponds to first elements of the application and at least one token data structure within the plurality of data structures corresponds to second elements of the application.

19. The method of claim 13, wherein each token in the one or more tokens corresponds to at least one of a word, a phrase, or an abbreviation within the library.

20. A non-transitory computer readable medium including instructions that when executed by one or more processors, cause the one or more processors to:
receive, from a computing device, a request to generate a token data structure including one or more tokens, the request indicating an application of a remote server;
determine, responsive to receiving the request, the one or more tokens to map to each element of the application according to a plurality of mappings for each token in the one or more tokens within a library;
generate the token data structure by using the plurality of mappings for each token within the library according to a framework for the one or more tokens within the token data structure, the framework ordering the one or more tokens to identify each element of the application;
identify a flag for the token data structure indicating acceptance or rejection by executing a validation function on a plurality of token data structures, each token data structure within the plurality of token data structures corresponding to the application of the remote server;
and transmit, to the computing device, the token data structure according to the flag indicating acceptance causing the computing device to update the plurality of token data structures to include the token data structure and display the token data structure.
